(19) United States
(12) Patent Application Publication
(10) Pub. No.: US 2013/0031567 A1
(43) Pub. Date: Jan. 31, 2013

(54) LOCAL EVENT PROCESSING

(71) Applicants: Olivier Nano, Aachen (DE); Ivo Santos, Aachen (DE); Marcel Tilly, Heinsberg (DE); Tomer Verona, Redmond, WA (US)

(72) Inventors: Olivier Nano, Aachen (DE); Ivo Santos, Aachen (DE); Marcel Tilly, Heinsberg (DE); Tomer Verona, Redmond, WA (US)

(73) Assignee: Microsoft Corporation, Redmond, WA (US)

(21) Appl. No.: 13/189,566

(22) Filed: Jul. 25, 2011

(51) Int. Cl. G06F 9/46

(52) U.S. Cl. 719/318

(57) ABSTRACT

The claimed subject matter provides a method for processing a stream of events. The method includes receiving a stream of events at a local device. The stream of events is associated with the local device. Further, the stream of events includes one or more out-of-order events. The method also includes executing a first complex event processing query against the stream of events. The stream of events is processed based on multiple levels of consistency defined by a set of operators. Additionally, the method includes correcting the out-of-order events based on the set of operators. A first output is generated in which consistency is guaranteed based on the corrected out-of-order events. The method also includes sending the first output to a server that performs complex event processing on the output.

### BACKGROUND

In various industries, such as manufacturing, automotive, logistics, distribution, and retail, there is a need to process and correlate data generated at multiple data sources in real time. Such handling of data enables the building of low-latency analytics which make it possible for decision makers to make quick decisions in reaction to business demands. However, the raw data for these analytics typically comes from distributed devices which, usually, have limited capabilities in terms of memory and connectivity. Due to these constraints, it is generally not desirable to centralize this data for processing in a responsive manner.

Current approaches tend to provide a small set of operations for processing the data locally, or move the source data to a central place for later processing. However, the growing number of data sources, and the vast amount of raw data limits the scalability of these approaches. Further, by providing only a small set of operations, solutions tend to focus on a very specific and reduced subset of data. This generally reduces the accuracy and completeness of the results.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

The claimed subject matter provides a system and method for complex event processing. The method includes receiving a stream of events at a local device. The stream of events is associated with the local device. Further, the stream of events includes one or more out-of-order events. The method also includes executing a first complex event processing query against the stream of events. The stream of events is processed based on multiple levels of consistency defined by a set of operators. Additionally, the method includes correcting the out-of-order events based on the set of operators. A first output is generated in which consistency is guaranteed based on the corrected out-of-order events. The method also includes sending the first output to a server that performs complex event processing on the output.

Additionally, the claimed subject matter provides a system for complex event processing. The system may include a processing unit and a system memory. The system memory may include code configured to direct the processing unit to perform complex event processing on a local device. The complex event processing is performed for a local stream that comprises one or more out-of-order events. An aggregate stream is generated based on the complex event processing on the local device. Each of a specified set of operators performs an operation, and places the out-of-order events in sequence in the aggregate stream. The aggregate stream is sent to a server for further complex event processing.

Further, the claimed subject matter provides one or more computer-readable storage media. The computer-readable storage media may include code configured to direct a processing unit to perform complex event processing on a local device. The complex event processing is performed for a local stream that comprises one or more out-of-order events. An aggregate stream is generated based on the complex event processing on the local device. Each of a specified set of operators performs an operation, and places the out-of-order events in sequence in the aggregate stream. Local analytics are generated for the local device based on the complex event processing, and displayed in an interface.

### BRIEF DESCRIPTION OF THE DRAWINGS

FIG. 1 is a block diagram of a database application system;

FIG. 2 is a block diagram of an event-driven application system, in accordance with the claimed subject matter;

FIG. 3A is a block diagram of a complex event detection and response (CEDR) system, in accordance with the claimed subject matter;

FIG. 3B is a timeline of example events, in accordance with the claimed subject matter;

FIG. 4 illustrates operators and operator algorithms in the CEDR system, in accordance with the claimed subject matter;

FIG. 5 illustrates a method of processing a stream of events, in accordance with the claimed subject matter;

FIG. 6 is a block diagram of a system for local and global analytics, in accordance with the claimed subject matter;

FIG. 7A is a diagram of a system for complex event processing, in accordance with the claimed subject matter;

FIG. 7B is a diagram of an example client with a device dashboard, in accordance with the claimed subject matter;

FIG. 8 is a diagram of an example device dashboard, in accordance with the claimed subject matter;

FIG. 9 is a diagram of the device dashboard 814, in accordance with the claimed subject matter;

FIG. 10 is a diagram of the device dashboard with a calendar application, in accordance with the claimed subject matter;

FIG. 11 is a block diagram of an exemplary networking environment wherein aspects of the claimed subject matter can be employed; and

FIG. 12 is a block diagram of an exemplary operating environment for implementing various aspects of the claimed subject matter.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As utilized herein, the terms “component,” “system,” “client” and the like are intended to refer to a computer-related entity, either hardware, software (e.g., in execution), and/or firmware, or a combination thereof. For example, a component can be a process running on a processor, an object, an executable, a program, a function, a library, a subroutine, and/or a computer or a combination of software and hardware.

By way of illustration, both an application running on a server and the server can be a component. One or more components can reside within a process and a component can be localized on one computer and/or distributed between two or more computers. The term “processor” is generally understood to refer to a hardware component, such as a processing unit of a computer system.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any non-transitory computer-readable device, or media.

Non-transitory computer-readable storage media can include but are not limited to magnetic storage devices (e.g., hard disk, floppy disk, and magnetic strips, among others), optical disks (e.g., compact disk (CD), and digital versatile disk (DVD), among others), smart cards, and flash memory devices (e.g., card, stick, and key drive, among others). In contrast, computer-readable media generally (i.e., not necessarily storage media) may additionally include communication media such as transmission media for wireless signals and the like.

Of course, those skilled in the art will recognize many modifications may be made to this configuration without departing from the scope or spirit of the claimed subject matter. Moreover, the word “exemplary” is used herein to mean serving as an example, instance, or illustration. Any aspect or design described herein as “exemplary” is not necessarily to be construed as preferred or advantageous over other aspects or designs.

While some approaches to analytics do some initial pre-processing in the data sources themselves, they typically do not offer rich analytics capabilities based on operators derived from a complex algebra. Instead, pre-processing is either very simple or hard-coded, and not very flexible. The lack of flexibility is problematic because analytics running on devices is typically planned in advance. As such, there is no opportunity to easily adapt such analytics during the lifetime of a device without physically flashing new or modified analytics to the device.

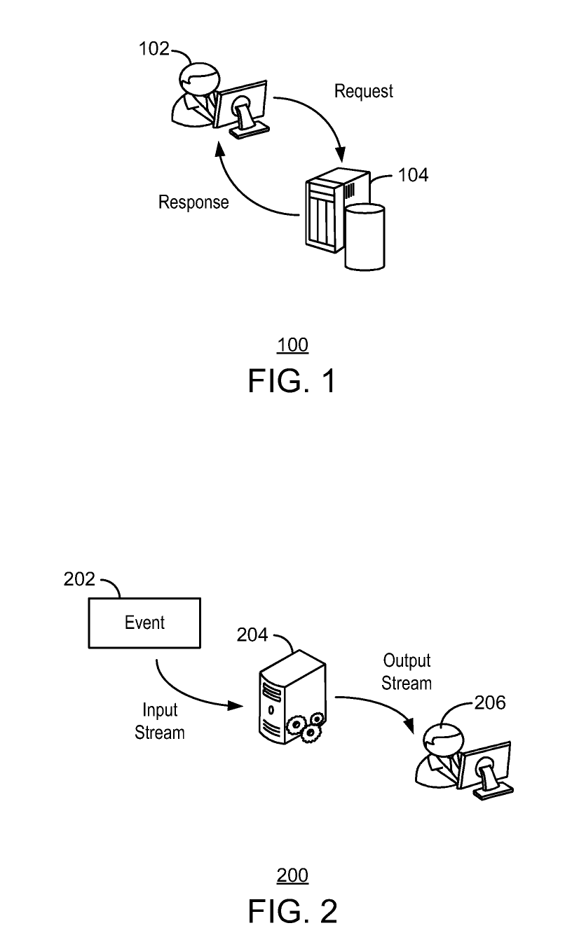

FIG. 1 is a block diagram of a database application system 100. Traditional database applications can provide analytics using ad-hoc queries, and requests. In the system 100, a user 102 may request analytics from a database server 104, hosting event data. The analytics may be provided in a response to the user 102. Query semantics may involve declarative relational analytics. Declarative relational analytics are SQL-type analytics, the same class of computation available on typical database systems. Declarative relational analytics may be non-temporal. For example, it may be cumbersome to compute the deviation of a system per hour in 10 minute-increments. In one embodiment, the analytics may be temporal. In one embodiment, the temporal analytics enable an out-of-order property for events. Further, these analytics may use a system clock time, but not an application time. In this way, temporal analytics may enable a new type of computation where time is a first class citizen. The latencies for such requests may be in time frames of seconds, and upwards to days. Results may be processed at a data rate of hundreds of events per second. However, analytical results reflect highly relevant information about dynamic business environments. As such, the advantage provided by such analytics is improved inversely with latency.

In comparison to database applications, event-driven applications may provide several advantages. Continuous standing queries have latencies at milliseconds and lower. Tens of thousands of events may be processed per second. The query semantics use declarative relational, and temporal, analytics. FIG. 2 is a block diagram of an event-driven application system 200, in accordance with the claimed subject matter. In the system 200, an event 202 is fed as an input stream to a continuous standing query 204. Advantageously, continuous standing queries 204 provide a high level of abstraction, and are processed in memory. The user 206 receives an output stream of analytics from the query 204.

Event-driven applications provide a different paradigm than traditional database applications, where the applications drive the results. In event-driven applications, the events drive the results. Results are produced as events arrive to the standing queries. Events are input as streams, each event including a payload of data, and associated with a time. Rich payloads may capture a number of properties about an event. Events expose different temporal characteristics. For example, events may occur at a point in time. Events may also include interval events of fixed, or unbound, duration. Accordingly, events may include a start time and an end time. The events may share a schema. All events may have a shared set of attributes. Events may not be stored, and internal transactions are not provided. In one embodiment, multiple streams may be joined based on relationships, and overlaps in time. The overlaps in time may result in events from multiple streams be processed concurrently by the standing query.

Many new requirements for streaming and event processing systems have been developed and used to design stream/event processing systems. These requirements derive from a multitude of architectures and applications. These may include sensor networks, large scale system administration, internet scale monitoring, stock ticker data handling, etc. Events from these streaming applications are frequently sent across unreliable networks resulting in the events arriving at the associated stream processing system out of sequence. While there are solutions to such issues, the solutions have drawbacks. As such, performance and correctness requirements are configured to balance tradeoffs between these requirements. Due to different performance, correctness requirements across different domains, systems have been vertically developed to handle specific tradeoffs. These requirements include continuous queries (e.g., computing a one minute moving average for heat across a sensor network), insert/event rates that are very high (e.g., orders of magnitude higher than a traditional database can process inserts), and query capabilities for handling increasingly expressive standing queries (e.g., stateful computation such as join). While streaming systems exist for specific vertical markets, broad adoption of a single system across a wide spectrum of application domains remains unattained. This is due in part to a requirement for domain-specific correct handling of out-of-order data and data retraction.

In one embodiment, an approach for handling stream imperfections may be based on speculative execution. Speculative execution means the system produces results based on potentially incomplete or inaccurate sets of input events, and will compensate the results as the set of inputs event become accurate. In such an embodiment, the retraction of incorrect events may be facilitated using operators to remove speculatively produced incorrect output. Additionally, parameters may be used that define a spectrum of consistency levels. A first parameter, maximum blocking time, exposes a tradeoff between a degree of speculation and latency. A second parameter, the maximum time data is remembered before being purged from the system, exposes a tradeoff between state size and correctness. Varying these two parameters may produce a spectrum of consistency levels (e.g., strong, middle, weak) which address the specific tradeoffs built into other systems.

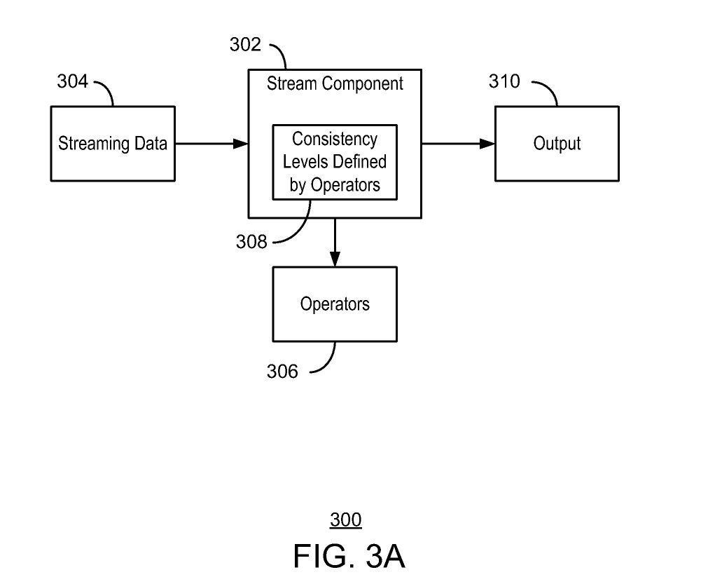

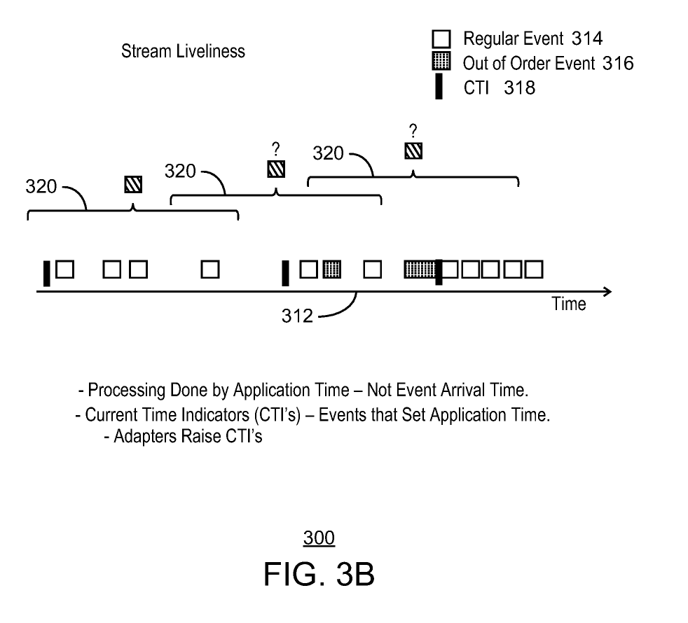

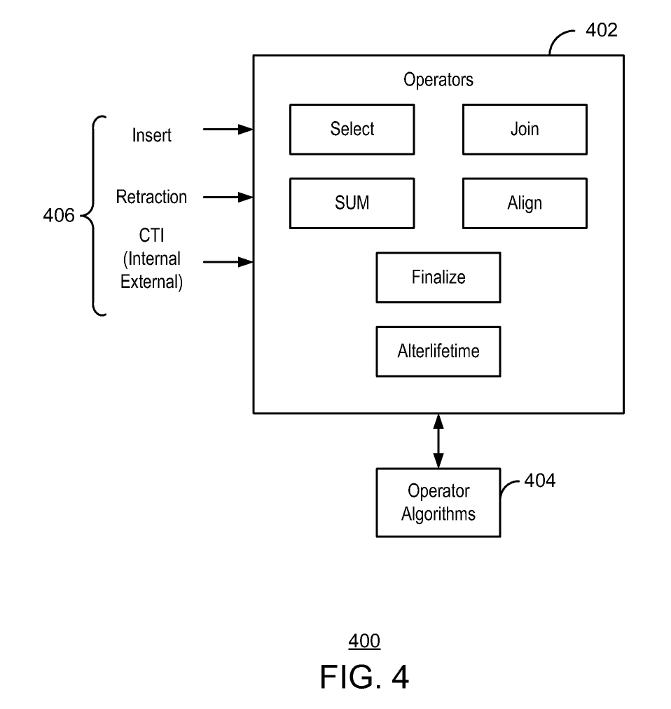

FIG. 3A is a block diagram of a complex event detection and response (CEDR) system 300, in accordance with the claimed subject matter. The system 300 includes a stream component 302 for receiving stream data 304. Stream data 304 includes a set of events. The stream component 302 may include an adapter (not shown) for receiving events from the event source. The adapter may also enqueue the received events for processing. The events may have data imperfections resulting from speculative execution. Events may have various arrival patterns, which may be steady, intermittent, random, or bursts. Some streams may end with an event indicating the end of the stream. The system 300 includes a set of operators 306 for providing multiple consistency levels 308 via which consistency in the output 310 is guaranteed. Correction of the output is based on retraction, and may be accomplished using operators described with respect to FIG. 4.

FIG. 3B is a timeline of example events, in accordance with the claimed subject matter. The timeline includes various events arriving at various times 312. The events include regular events 314, out of order events 316, and current time indicator (CTI) events 318. The CTI events 318 may be events that update application time. Every event has an application time. However, CTI events 318 enables the system 300 to discard events with an application time older than the last CTI. The application time is the clock that event providers use to timestamp events created by the providers. The system 300 may process events in order of application time, not the event arrival time, because events may arrive out of order. Out of order events may be those where the order of arrival does not match the order of the events' respective application times. Events may be processed within windows 320, which may overlap. The windows 320 may be windows of application time. Each event arriving within a window may be processed in an incremental execution of a continuous query by the stream component 302. The question marks represent output results generated with input events received out of order.

FIG. 4 illustrates operators 402 and operator algorithms 404 in the CEDR system 300, in accordance with the claimed subject matter. Retraction may be accomplished using operators 402 that include Select, AlterLifetime, Join, Sum, Align, Finalize, and others. In one embodiment, the operators 402 may be extended with domain-specific operators. The domain-specific operators may be integrated with the functionality of the operators 402. Further, new operators may be added to the operators 402. The algorithms 404 may be defined for streaming operators. Streaming operators may be operators 402 that produce speculative output. The algorithms 404 may implement the entire spectrum of consistency levels for a rich computational model based on relational algebra. Moreover, the algorithms 404 are provably efficient, and may be within a logarithmic value of being optimal, or better, for the worst case scenarios. When state is bounded, as is typically the case for windowed queries over well-behaved streams, the algorithms are linear, optimal, and have state complexity of O(1).

The algorithms 404 may be used for three view update compliant operators: a stateless operator (Select or Selection), a join-based operator (Equijoin), and an aggregation-based operator (Sum). A view update compliant operator is an operator that produces identical output snapshots for identical input snapshots. The operators 402 may be represented algebraically, according to equations described below. In these equations, E(S) represents a set of events in the infinite canonical history table for a stream, S. A canonical history table is a history table in which all retracted rows are removed, and all rows whose events are fully retracted are removed. Further, the system time, which is not part of the canonical table, may be projected out for each row. Conventional stream systems use bi-temporal models, separating the notion of application time and system time. System time is the clock of the receiving stream processor. In one embodiment, a, tri-temporal model may be used. This tri-temporal model may further refine application time into occurrence time and valid time, thereby providing a tri-temporal model of occurrence time, valid time, and system time.

The Select operator may correspond to relational selection, and use a Boolean function, f, which operates over the payload. The Select operator may be represented algebraically, according to Equation 1:

Selection σ_{f}(S)={(e·Vₛ,e·Vₑ,e·Payload)|eεE(S) where f(e·Payload)} EQUATION 1

The Join operator, may be represented as a Boolean function over two input payloads, according to Equation 2:

Join^{|x|}_{θ(P1,P2)}(S₁,S₂)={(Vₛ,Vₑ,(e₁·Payload concatenated with e₂·Payload))|e₁ε∪L(S₁), e₂εE(S₂), Vₛ=max {e₁·Vₛ,e₂·Vₛ}, V₃=min {e₁·Vₑ,e₂·Vₑ}, where Vₛ<Vₑ, and θ(e₁·Payload,e₂·Payload)} EQUATION 2

The Join operator semantically treats the input streams as changing relations, where the valid time intervals are the intervals during which the payloads are in the respective relations. The output of the Join describes the changing state of a view which joins the two input relations. In this way, many operators follow view update semantics.

The Sum operator may be materialized-view compliant, meaning the operator generates a materialized view, which is a synopsis structure precomputed from one or more event sets. The Sum operator adds the values of a given column for all rows in a snapshot, starting at the earliest possible time. A snapshot is a set of events that are being processed by a particular operator at a particular time. The Sum operator may be implemented without retractions if there are no retractions in the input, and all events arrive in Vₛ order. More specifically, only sums associated with snapshots which precede the arriving event's Vₛ are output. It is noted that the output event lifetimes have valid start and end points, determined by the valid start and end points of the input events. This may be so because the output sum values may only change when an input tuple is added or removed from the modeled input relation. The Sum operator may be represented as sum_{A}(S), according to Equation 3:

C={e·Vs|eεS}∪{e·Vₑ|eεS}ε{0} Let C[i] be the ith earliest element of C, sum_{A}(s)={Vₛ,Vₑ,α)∥C|>t>=1, V_{S}=C[t], Vₑ=C[t+1], α=Σ_{cεS, e·V}_{ₛ}_{<=V}_{ₛ}_{,V}_{ₑ}_{<=e·V}_{ₑ}_{}}e·A} EQUATION 3

While all CEDR computational operators are well-behaved, not all are view update compliant. For example, the streaming-only operators (e.g., windows, deletion removal) are not view update compliant. In CEDR, these operators can be modeled with the AlterLifetime. Operator. The AlterLifetime operator takes two input functions, f_{Vs(e)} and f_{Δ(e)}. As such, AlterLifetime maps the events from one valid time domain to another valid time domain. In the new domain, the new Vₛ times are computed from f_{Vs}, and the durations of the event lifetimes are computed from f_{Δ}. The AlterLifetime operator may be represented according to Equation 4:

AlterLifetimeπ_{fvs,fΔ}(S)={(|f_{—}Vs(e)|,|f_{—}Vs(e)|+|f_Δ(e)|,e·Payload)|eεE(S}} EQUATION 4

From a view update compliant operator perspective, AlterLifetime has the effect of reassigning the snapshots to which various payloads belong. AlterLifetime can therefore be used to reduce a query which crosses snapshot boundaries (e.g., computing a moving average of a sensor value) to a problem which computes results within individual snapshots, and is therefore, view update compliant. For instance, a moving window operator, denoted W, is a special instance of π. This operator takes a window length parameter wl, and assigns the validity interval of its input based on wl. More precisely: W_{wl}(S)=π_{Vs,wl}(S). Once using AlterLifetime in this manner, each snapshot of the result contains all tuples which contribute to the windowed computation at that snapshot's point in time. Therefore, when this output is fed to Sum, the result is a moving sum with window length wl.

A similar definition for hopping windows can be obtained using integer division. Hopping windows are windows that “hop” forward in time by a specified period. Finally, the AlterLifetime operator can be used to easily obtain all inserts and deletes from a stream. These may be represented as shown in Equations 5-6:

Inserts(S)=π_{Vs ∞}(S) EQUATION 5

Deletes(S)=π_{Vs ∞}(S) EQUATION 6

The operators 402 are further described using an example of streaming data 304 where a fleet of cars are the data source. Accordingly, each event in the streaming data 304 may include a number of attributes about the car. The operators 402 may further include operators, such as Project, Exists, Filter, Group, Apply, Count, and Top-K. The Project operator may perform calculations, or isolate selections on streaming data 304. An example result may include a color attribute for each car. The Exists operator may check for an absence of activity from a data source, such as a group of cars. The Filter operator may select events from the streaming data 304, according to specific filtering parameters. For example, the Filter operator may provide a result including only events coming from trucks.

The Group and Apply operators may partition the streaming data 304 into windows of time. Accordingly, a continuous query may be applied to all events in the window. Aggregation may be performed with operators, such as Sum, and Count. The Top-K operator may be used to rank events according to specified attributes of the events.

The Align and Finalize operators respond to individual events as the events arrive at the CEDR system. While the system time is implicitly encoded in the event arrival order, system time is not explicitly part of an event. System time is also referred to herein as CEDR time. CEDR operators 402 receive three types of events 406, sequentially. The first type of event is an insert, which corresponds semantically to insert events 406 in the CEDR bitemporal model (valid time and system time, but not occurrence time). Insert events 406 come with Vₛ and Vₑ timestamps, and also a payload. It is noted that the CEDR system uses bag semantics, and, therefore, can receive two inserts with identical payloads and identical life spans.

The second type of event is a retraction, which corresponds semantically to retractions in the CEDR bitemporal model. For retraction, only the new validity time is provided, making the CEDR bitemporal. The start time is already know from the previous insert. Since retractions are paired with corresponding inserts or previous retractions, pairing is established using global event IDs or by including in the retraction sufficient information to establish the pairing. If using global IDs, certain stateless operators (e.g., Select) become more complicated. Since retractions are far less common than inserts, all necessary information will be included in the retraction to establish the connection with the original insert. Note, however, that the algorithms presented described herein can be adapted to make use of global IDs, if desirable. CEDR physical retractions may include the original valid time interval, Vₛ and Vₑ, the new end valid time V_{newe}, and the payload values from the original insert.

An example event stream is shown in Table 1:

TABLE 1

| Event | | | | |
|---|---|---|---|---|
| Type | Vₛ | Vₑ | V_{Newe} | (Payload) |
| Insert | 1 | ∞ | | P1 |
| Retract | 1 | ∞ | 10 | P1 |
| Retract | 1 | 10 | 5 | P1 |
| Insert | 4 | 9 | | P2 |

The third type of event, referred to herein as a current time increment (CTI), may be used in the event stream in a way similar to punctuation. The CTI event 418 may consist of a single field that provides a current timestamp. The CTI event 418 may indicate to the system 300 that no subsequent insert events have a start time less than the timestamp of the CTI event 418. In other words, the CTI event 418 is a special punctuation event that indicates the completeness of the existing events. The CTI may be a timestamp Vₑ. According to a semantics of the message, all events 406 have arrived in the stream where the event synchronization (sync) times are less than the accompanying timestamp. More specifically, the sync times for insert events 406 occur at Vₛ, while the sync times for retraction events 406 occur at V_{newe}.

There are two types of CTIs. The first type is an internal CTI, which may not be reordered to a position in the stream prior to its earliest correct placement. This corresponds to the CTI described in the earlier paragraph. The second type of CTI, called an ExternalCTI, can arrive arbitrarily out-of-order relative to the rest of the stream contents. As described herein, Finalize is defined only to the handling of ExternalCTIs, which converts out-of-order external CTIs into ordered internal CTIs. External CTIs have a Vₛ, a Vₑ, and a Count. The Count events 306 may be CTI events 418 whose sync times are in the timestamp interval. [Vₛ,Vₑ). Furthermore, while ExternalCTIs may arrive arbitrarily out-of-order, ExternalCTIs have non-overlapping valid time intervals. The system 300 and operators 402 are described in greater detail in U.S. Patent Application Publication No. 2009/0125635, which is hereby incorporated by reference in its entirety.

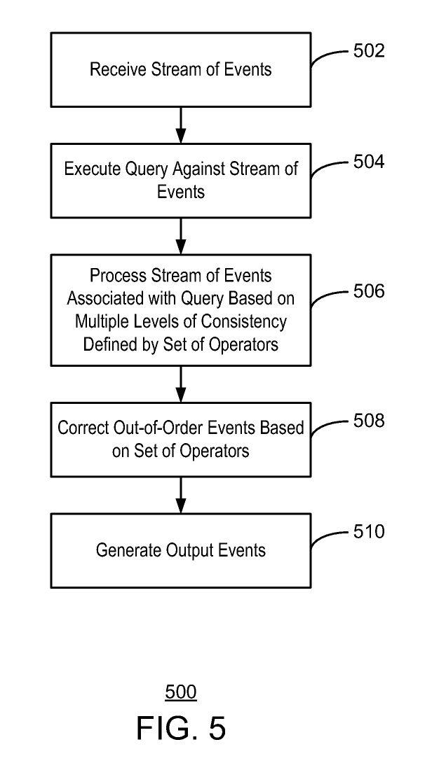

FIG. 5 illustrates a method 500 of processing a stream of events, in accordance with the claimed subject matter. At 502, a stream of events is received. The stream of events includes out-of-order events that are based on speculative execution. At 504, a query is executed against the stream of events. At 506, the stream of events associated with the query is processed based on multiple levels of consistency defined by a set of operators. At 508, the out-of-order events are corrected based on the set of operators. At 510, an output is generated. In the output, consistency is guaranteed based on the corrected out-of-order events.

Typically, event-driven applications are processed at a backend server. However, this approach is becoming increasingly challenging because transporting all data to a central server becomes a bottleneck as data generation increases. With the increasing proliferation of mobile devices, including intelligent devices, and other technology, data generation is rapidly increasing. In contrast, improvements in bandwidth and server capacities may rise more steadily. By moving more processing to the data source, the amount of bandwidth used may be reduced. Accordingly, such applications may scale well. Further, by implementing complex event processing at local devices, more meaningful, and personalized data may be produced. In this way, event data may be processed as it is generated, and directly on the equipment generating the data. Such an embodiment provides several advantages. Complex event processing performed at the data source is low latency. Further, such systems may be seamlessly integrated with a backend or cloud systems to perform stream processing.

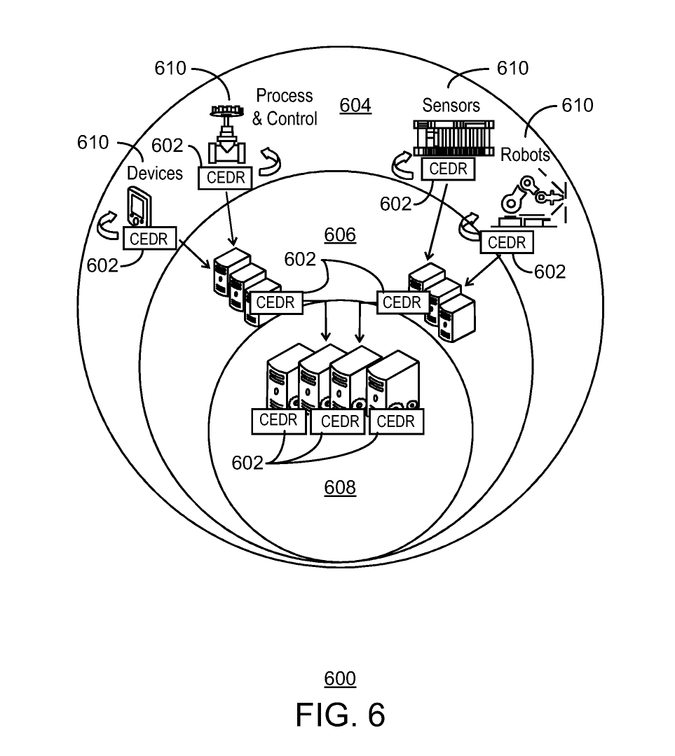

FIG. 6 is a block diagram of a system 600 for local and global analytics, in accordance with the claimed subject matter. In the system 600, CEDR systems 602 may be deployed at an edge 604, a mid-tier 606, and a data center 608. Complex event processing is distributed throughout the system 600. At the edge 604, the CEDR system 602 may perform lightweight processing and filtering, and provide local analytics. The mid-tier 606 may include servers 608 that aggregate data filtered at the edge 604. Further, at the mid-tier 606, the CEDR 602 may consolidate related data sources 610. Additionally, the CEDR system 602 may correlate in-flight events. In-flight events are event streams coming directly from the system or application that produced the data. The events have not been persisted. At the data center 608, a historical archive may be maintained. Further, the CEDR system 602 may perform complex analytics and data mining. Additionally, at the data center 608, the CEDR 602 may perform large scale correlations.

The mid-tier 606 and data center 608 are also referred to herein as a cloud. The cloud may be a private cloud, backend, etc. In the cloud, analytics may be determined for a large number of local devices. These global analytics may be used to describe the overall efficiency of a monitored system. The edge 604 may include data sources 610, such as embedded devices, process and control data, sensors, phones, robots, etc. The data sources 610 may be local devices, clients, etc. The local analytics provided at the edge 604 may detect when a local device behaves outside a range of operational norms. Additionally, the local analytics may be used to detect new conditions on local devices. For example, the CEDR system 602 on the data sources 610 may inspect different event streams and recognize, through pattern mining, when new patterns are detected. For example, the CEDR system 602 in an electric car data source, may detect when the battery charge decreases faster than it has historically. The system 600 may be useful in a retail environment for fraud detection. Fraud committed at the point of sale may be more rapidly detected using local analytics at the local devices. Global analytics may help reveal fraud through the detection of patterns of suspicious activities across products, channels, etc.

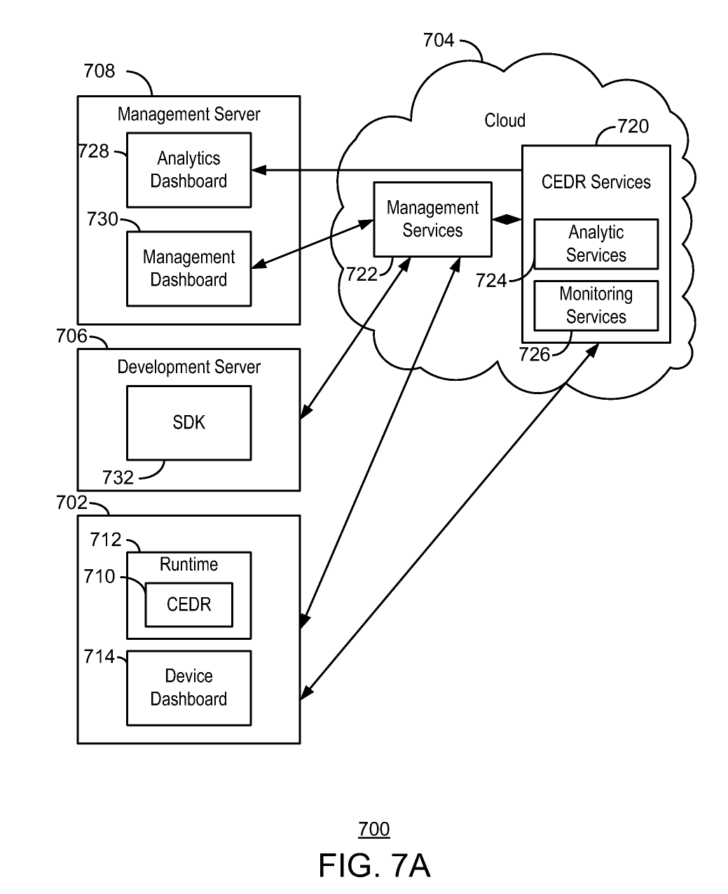

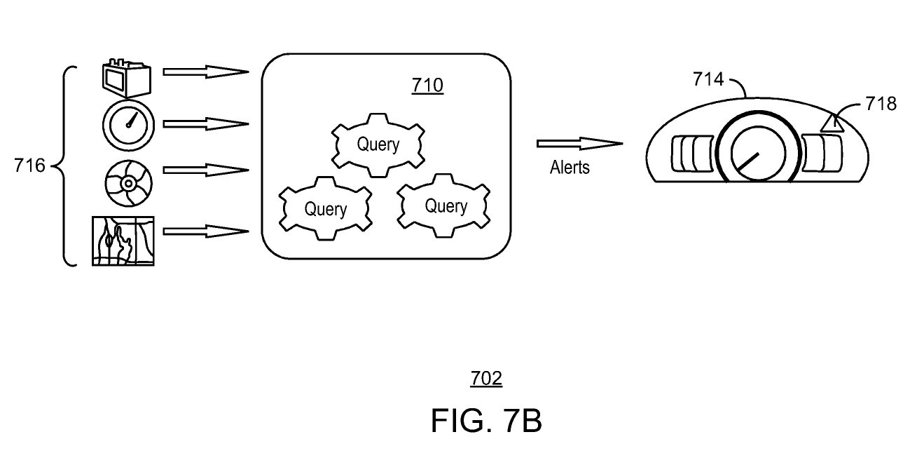

FIG. 7A is a diagram of a system 700 for complex event processing, in accordance with the claimed subject matter. The system includes clients 702, a cloud 704, a development server 706, and a management server 708. CEDR Applications 710 are deployed on the clients 702, as embedded applications of a cross-platform runtime 712. The runtime 712 is software configured to support the execution of computer programs written in a specific computer language. Typically, the runtime 712 includes low and high-level commands, type-checking, debugging. In some instances, the runtime 712 may even provide code generation and optimization. The runtime 712 may be supported on various clients 702, such as the local devices described with reference to FIG. 6. The CEDR applications 710 perform stream processing in accordance with the CEDR system 300, and provide analytics for use by a device dashboard 714. The device dashboard 714 may be a visual interface that provides monitors, alarms, etc., for the local device based on analytics provided by the CEDR applications 710. In one embodiment, an application framework, such as Silverlight®, or Flash®, may be used to support the visual interface across various platforms of clients 702. In one embodiment, the device dashboard 714 may be useful in improving the use of on-board diagnostics (OBD). Passenger cars typically include OBD systems that report diagnostic information and standardized fault codes according to OBD regulations. In the system 700, the OBD may be configured and adapted responsively to conditions detected by OBD systems.

The CEDR applications 710 may process streaming events to provide monitoring and operational data that is filtered, aggregated, etc., for further processing at the cloud 704. The local analytics generated at the clients 702 may be rolled up for further processing on larger nodes in the cloud 704, to produce global analytics. In this way, the system 700 may avoid moving large volumes of raw data to the cloud 704. Further, the frequency with which data is moved may also be reduced, in comparison to a typical complex event processing system. Advantageously, this may be accomplished without degrading the accuracy of the analytics. Global analytics may include operational data, fleet data, service level agreement (SLA) violations, business SLA data, recommendations, fleet-wide metrics, key performance indicators, etc. An SLA typically specifies a set of metrics used to measure a service that holds the owner of the service accountable for matching these metrics.

The cloud 704 may provide CEDR services 720 and management services 722, which may be cloud services. Similar to the CEDR applications 710, these cloud services perform stream processing in accordance with the CEDR systems 300. The CEDR applications 710 and the CEDR services 720 may have the same semantics, which may enable the system 700 to provide low-latency analytics, both in the cloud 704, and on the clients 702. This may be accomplished with the CEDR applications 710 doing local, low-latency, complex event processing on the clients 702, where the raw data is created.

The clients 702 typically have limited capabilities, such as limitations in memory, connectivity, processor speed, etc. Limited connectivity may result from data source devices that are not persistently connected to a network. Other connectivity limitations may result from restrictions regarding bandwidth. In some cases, limitations in memory limit the size of software implementations, such as complex event processing. For local devices that may be intermittently connected to a network, the system 700 may support clients 702 that become disconnected from the cloud 704. In such a scenario, the CEDR applications 710 may perform the local analytics processing, and store the results locally until a connection to the cloud 704 is re-established, when the stored results may be forwarded. Due to the passing of time during, the forwarded results may arrive out of order at the cloud 704. Advantageously, the operators 402 used in the CEDR services 720 support complex event processing for events received out of order.

The CEDR services 720 may include analytic services 724 and monitoring services 726. The analytic services 724 may provide global analytics, analytics for groups of clients 702, etc. The monitoring services 726 may monitor the execution of the system 700 from clients 702 to the cloud 704, by analyzing performance measures. The analytic services 724 and monitoring services 726 may provide data for display, or further processing at an analytics dashboard 728 on the management server 708. The analytics dashboard 728 may enable a user of the system 700 to visualize results of the analytics. The management server 708 may also include a management dashboard 730. The management dashboard 730 may be used in concert with the management services 722 to centrally manage the deployment of CEDR applications 710, CEDR services, etc. New analytical queries, e.g., CEDR applications 710 may be pushed down to the clients 702 with management services 722. Further, this central management may provide a way to perform dynamic, on-the-fly updates of the system 700 The management dashboard 730 may enable a user to select various CEDR applications 710, CEDR services 720, etc., for deployment to the clients 702, and cloud 704, respectively. The management services 722 may deploy the selected applications in response to requests from the management dashboard 730. The management dashboard 730, and management services 722, may also enable the user to manage categories of clients 702, which is advantageous in systems 700 with many different types of device. Additionally, the deployment and management may accord with constraints for networks, overlays, and data selectivity. An overlay network is a computer network built on top of another network. A node in the overlay can be thought of as being connected by virtual or logical links, each of which corresponds to a path, perhaps through many physical links, in the underlying network.

Advantageously, the various applications, services, dashboards may be developed on the development server 706, using a single software development kit (SDK) 732. The SDK 732 may provide a universal development experience for a programmer developing the applications, dashboards, and services for the system 700. The SDK 732 may include development tools for the creation of applications according to a specific implementation. The implementations may vary according to software frameworks, hardware platform, and various other architectures. As the semantics are the same for the applications and services providing the various analytics, the SDK 732 may accord with the operators used to provide the analytics, e.g., the operators 402. The SDK 732 may also provide an interface to implement user-defined operators. Further, because the various applications share the same semantics, the results of the processing may be the same, whether done at the client 702, or in the cloud 704. Because the queries' semantic is well-defined, the processing may be performed at the device level, or on the server. Further, the first part of the processing may be performed on the device and the last part of the processing performed on the server. As long as it is the same query, the result is the same. However, if all processing is performed on the server, all the data is moved first, making such an architecture more complex. If, instead, the query is partitioned across devices, and the server the result may be the same, but advantageously, much less data is moved. Further, the operators 402 may be chained, which provides for more flexibility in terms of the programming logic for the applications, etc.

The system 700 may support a heterogeneous and dynamic architecture of clients 702, CEDR applications 710, CEDR services 720, etc. This is illustrated using an example client 702 of a car, described with respect to FIG. 7B.

FIG. 7B is a diagram of an example client 702 with a device dashboard 714, in accordance with the claimed subject matter. In this example, the client 702 may be an electric powered vehicle that receives streaming events from various components 716 of the vehicle. The components 716 may include a battery, speedometer, and climate controls, such as air conditioning, etc. Each of the components 716 may provide streams of events describing a battery charge, rate of speed, and power consumption by the climate controls, respectively. The components 716 may also include a communications component that provides a stream of traffic conditions, and locations of nearby recharging stations. In one embodiment, the CEDR applications 710 may process the streaming events to identify a condition about which to alert the driver. For example, the CEDR applications 710 may determine that the current power consumption is exceeding a specified threshold. Accordingly, an alert 718 may be displayed on the device dashboard 714. In one embodiment, the system 700 may be responsive to such an alert condition, and drill-down from the management server 708 to the client 702 to activate queries that provide more information about the alert condition. In addition to providing alert conditions, the device dashboard 714 may be used in the system 700 to provide customized solutions for the client 702

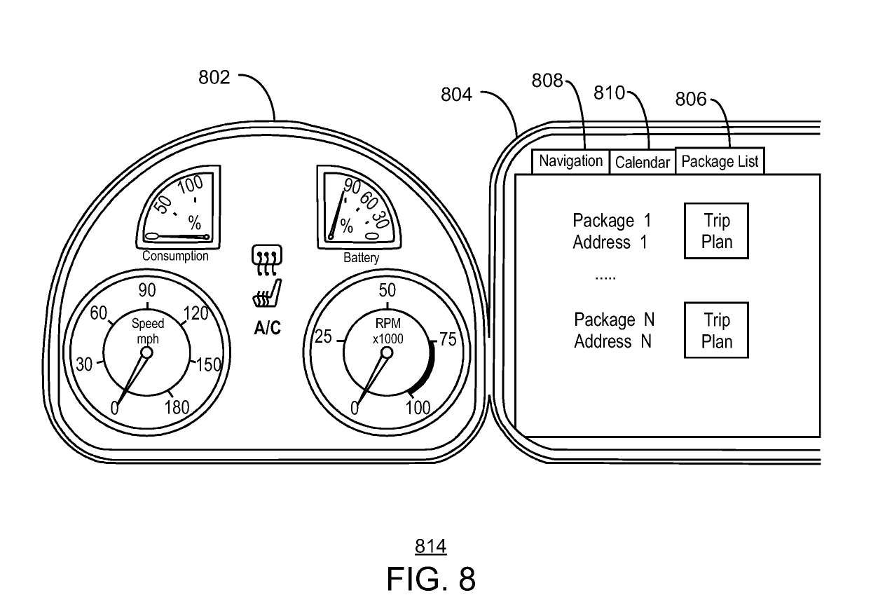

FIG. 8 is a diagram of an example device dashboard 814, in accordance with the claimed subject matter. The device dashboard 814 may be displayed on a car that is part of a fleet of delivery vehicles. The device dashboard 814 includes a standard display 802 for an electric car that includes a speedometer, odometer, battery meter, and an energy consumption meter. The device dashboard 814 also includes a touch screen interface 804 to tools supported by the CEDR applications 710. The interface 804 may include tabs for a package list 806, navigation 808, and calendar 810. The package list 806 may be arranged in the sequence that the driver is to deliver the packages. In one embodiment, the sorting may be based on streaming data regarding current location and traffic conditions. A CEDR application 710 may process this streaming data to provide a package list sorted in this way.

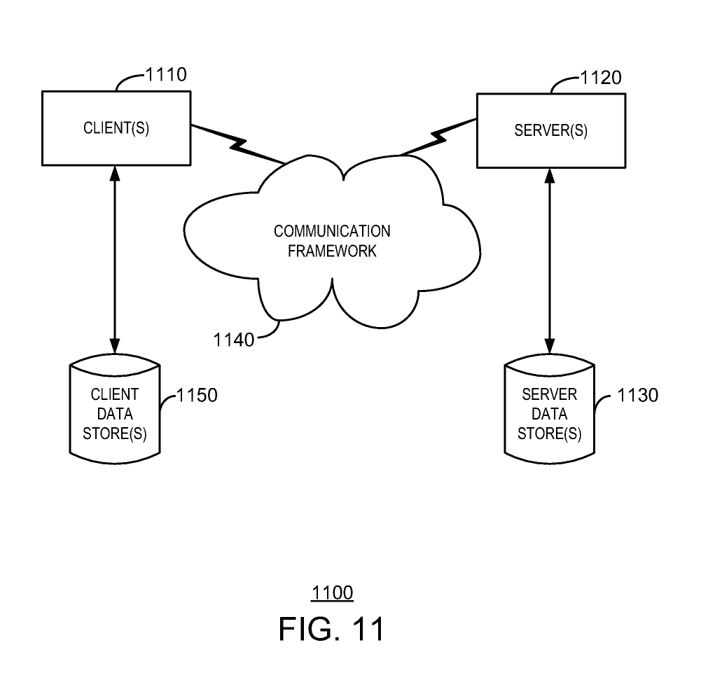

Each of the entries on the package list may include a trip planning button 812. In response to a user selection of the button 812, the device dashboard 914 may display a map with a highlighted rout on the tab for navigation 810, described with reference to FIG. 11.

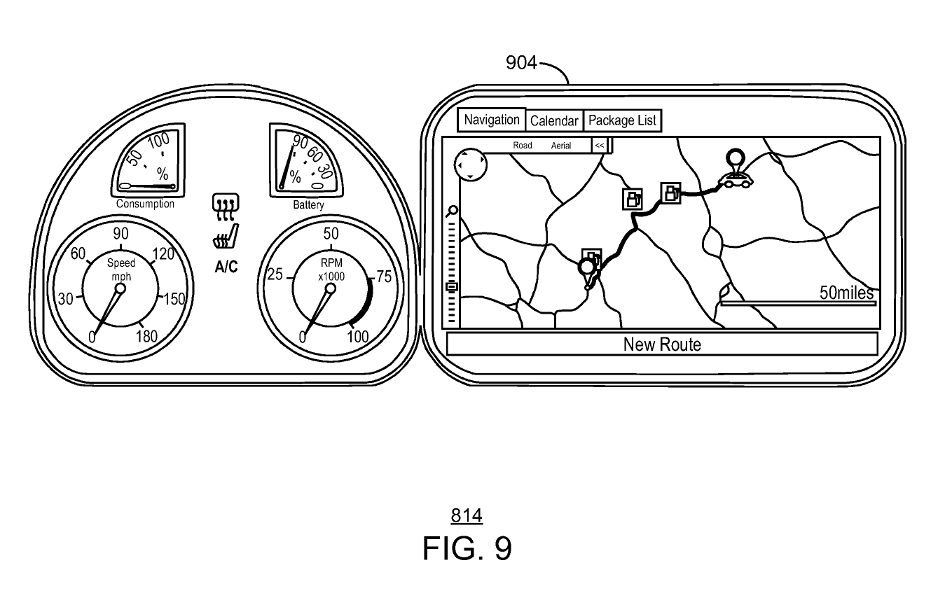

FIG. 9 is a diagram of the device dashboard 814, in accordance with the claimed subject matter. The interface 904 shows a map with a highlighted route 906 from the current location to the selected destination. The interface 904 may also include icons 908 that represent fueling stations along the route. In the case of an electric car, the icons 908 may represent charging stations. In one embodiment, a CEDR application 710 may use streaming data regarding consumption of fuel, battery power, etc., to determine which fueling stations are reachable from the current location. In such an embodiment, reachable fueling stations may be represented with a green icon, others, with a red icon. In some cases, the global analytics collected for the fleet of delivery vehicles may be used to improve the efficiency of the delivery vehicles. For example, global analytics may demonstrate that, for an electric car, greater efficiency is achieved by recharging when the car's battery as at 10-12% of capacity. As such, the CEDR applications 710 may be updated to identify, with the green icon, the charging stations can be reached with the battery at this level of charge. Charging stations that are reachable, but below this level of charge, may be represented with a yellow icon. The navigation application may execute in a partition such that operations data from the car may be used.

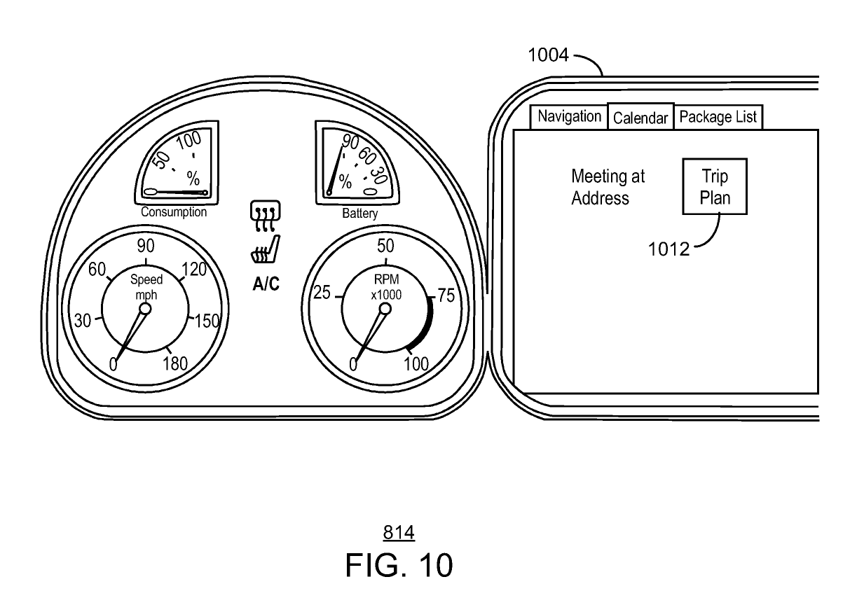

FIG. 10 is a diagram of the device dashboard 814 with a calendar application, in accordance with the claimed subject matter. The interface 1004 may be used to view and update calendar items, similar to a desktop calendar application. The calendar may include a trip planning button 1012 next to calendar entries with address data. In response to a user selection of the button 1012, device dashboard 814 may show the tab for navigation 808 described with respect to FIG. 9. The car's current location, fed from a data stream, may be used to calculate a route to the address specified in the calendar entry. The calendar application may be executing on a third party partition on the client 702.

FIG. 11 is a block diagram of an exemplary networking environment 1100 wherein aspects of the claimed subject matter can be employed. Moreover, the exemplary networking environment 1100 may be used to implement a system and methods for complex event processing, as described herein.

The networking environment 1100 includes one or more client(s) 1102. The client(s) 1102 can be hardware and/or software (e.g., threads, processes, computing devices). As an example, the client(s) 1102 may be computers providing access to servers over a communication framework 1108, such as the Internet.

The environment 1100 also includes one or more server(s) 1104. The server(s) 1104 can be hardware and/or software (e.g., threads, processes, computing devices). The server(s) 1104 may include network storage systems. The server(s) may be accessed by the client(s) 1102.

One possible communication between a client 1102 and a server 1104 can be in the form of a data packet adapted to be transmitted between two or more computer processes. The environment 1100 includes a communication framework 1108 that can be employed to facilitate communications between the client(s) 1102 and the server(s) 1104.

The client(s) 1102 are operably connected to one or more client data store(s) 1110 that can be employed to store information local to the client(s) 1102. The client data store(s) 1110 may be located in the client(s) 1102, or remotely, such as in a cloud server. Similarly, the server(s) 1104 are operably connected to one or more server data store(s) 1106 that can be employed to store information local to the servers 1104.

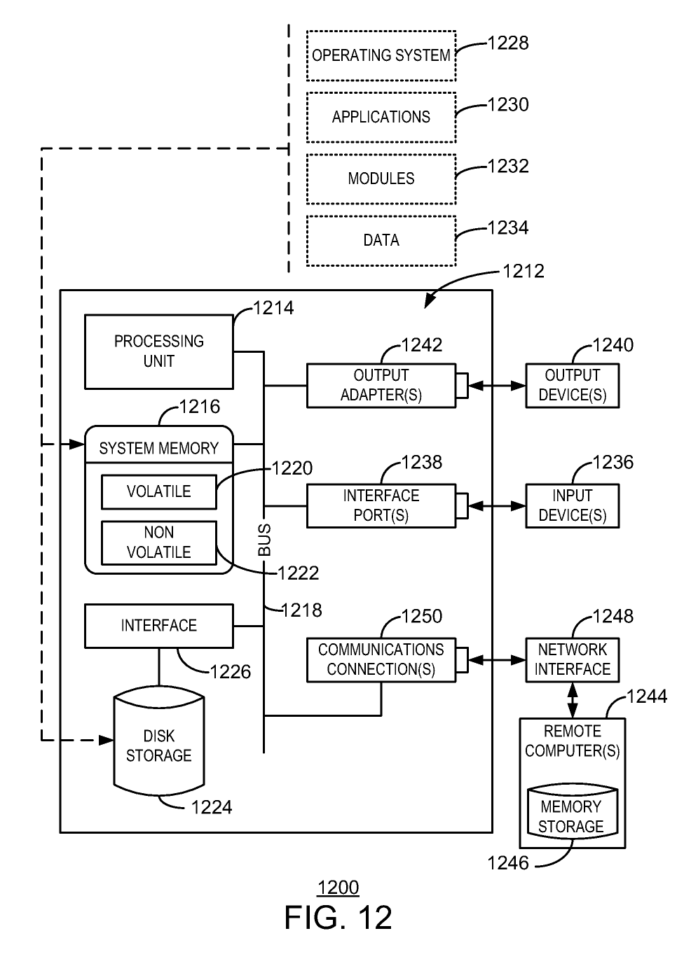

With reference to FIG. 12, an exemplary operating environment 1200 is shown for implementing various aspects of the claimed subject matter. The exemplary operating environment 1200 includes a computer 1212. The computer 1212 includes a processing unit 1214, a system memory 1216, and a system bus 1218. In the context of the claimed subject matter, the computer 1212 may be configured to execute transactions on distributed platforms.

The system bus 1218 couples system components including, but not limited to, the system memory 1216 to the processing unit 1214. The processing unit 1214 can be any of various available processors. Dual microprocessors and other multiprocessor architectures also can be employed as the processing unit 1214.

The system bus 1218 can be any of several types of bus structure(s) including the memory bus or memory controller, a peripheral bus or external bus, and/or a local bus using any variety of available bus architectures known to those of ordinary skill in the art. The system memory 1216 comprises non-transitory computer-readable storage media that includes volatile memory 1220 and nonvolatile memory 1222.

The basic input/output system (BIOS), containing the basic routines to transfer information between elements within the computer 1212, such as during start-up, is stored in nonvolatile memory 1222. By way of illustration, and not limitation, nonvolatile memory 1222 can include read only memory (ROM), programmable ROM (PROM), electrically programmable ROM (EPROM), electrically erasable programmable ROM (EEPROM), or flash memory.

Volatile memory 1220 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), SynchLink™ DRAM (SLDRAM), Rambus® direct RAM (RDRAM), direct Rambus® dynamic RAM (DRDRAM), and Rambus® dynamic RAM (RDRAM).

The computer 1212 also includes other non-transitory computer-readable media, such as removable/non-removable, volatile/non-volatile computer storage media. FIG. 12 shows, for example a disk storage 1224. Disk storage 1224 includes, but is not limited to, devices like a magnetic disk drive, floppy disk drive, tape drive, Jaz drive, Zip drive, LS-100 drive, flash memory card, or memory stick.

In addition, disk storage 1224 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1224 to the system bus 1218, a removable or non-removable interface is typically used such as interface 1226.

It is to be appreciated that FIG. 12 describes software that acts as an intermediary between users and the basic computer resources described in the suitable operating environment 1200. Such software includes an operating system 1228. Operating system 1228, which can be stored on disk storage 1224, acts to control and allocate resources of the computer system 1212.

System applications 1230 take advantage of the management of resources by operating system 1228 through program modules 1232 and program data 1234 stored either in system memory 1216 or on disk storage 1224. It is to be appreciated that the claimed subject matter can be implemented with various operating systems or combinations of operating systems.

A user enters commands or information into the computer 1212 through input device(s) 1236. Input devices 1236 include, but are not limited to, a pointing device (such as a mouse, trackball, stylus, or the like), a keyboard, a microphone, a joystick, a satellite dish, a scanner, a TV tuner card, a digital camera, a digital video camera, a web camera, and/or the like. The input devices 1236 connect to the processing unit 1214 through the system bus 1218 via interface port(s) 1238. Interface port(s) 1238 include, for example, a serial port, a parallel port, a game port, and a universal serial bus (USB).

Output device(s) 1240 use some of the same type of ports as input device(s) 1236. Thus, for example, a USB port may be used to provide input to the computer 1212, and to output information from computer 1212 to an output device 1240.

Output adapter 1242 is provided to illustrate that there are some output devices 1240 like monitors, speakers, and printers, among other output devices 1240, which are accessible via adapters. The output adapters 1242 include, by way of illustration and not limitation, video and sound cards that provide a means of connection between the output device 1240 and the system bus 1218. It can be noted that other devices and/or systems of devices provide both input and output capabilities such as remote computer(s) 1244.

The computer 1212 can be a server hosting various software applications in a networked environment using logical connections to one or more remote computers, such as remote computer(s) 1244. The remote computer(s) 1244 may be client systems configured with web browsers, PC applications, mobile phone applications, and the like.

The remote computer(s) 1244 can be a personal computer, a server, a router, a network PC, a workstation, a microprocessor based appliance, a mobile phone, a peer device or other common network node and the like, and typically includes many or all of the elements described relative to the computer 1212.

For purposes of brevity, only a memory storage device 1246 is illustrated with remote computer(s) 1244. Remote computer(s) 1244 is logically connected to the computer 1212 through a network interface 1248 and then physically connected via a communication connection 1250.

Network interface 1248 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1250 refers to the hardware/software employed to connect the network interface 1248 to the bus 1218. While communication connection 1250 is shown for illustrative clarity inside computer 1212, it can also be external to the computer 1212. The hardware/software for connection to the network interface 1248 may include, for exemplary purposes only, internal and external technologies such as, mobile phone switches, modems including regular telephone grade modems, cable modems and DSL modems, ISDN adapters, and Ethernet cards.

An exemplary processing unit 1214 for the server may be a computing cluster comprising Intel® Xeon CPUs. The disk storage 1224 may comprise an enterprise data storage system, for example, holding thousands of impressions.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable storage media having computer-executable instructions for performing the acts and/or events of the various methods of the claimed subject matter.

There are multiple ways of implementing the subject innovation, e.g., an appropriate API, tool kit, driver code, operating system, control, standalone or downloadable software object, etc., which enables applications and services to use the techniques described herein. The claimed subject matter contemplates the use from the standpoint of an API (or other software object), as well as from a software or hardware object that operates according to the techniques set forth herein. Thus, various implementations of the subject innovation described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical).

Additionally, it can be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A method for complex event processing, comprising:
receiving a stream of events at a local device, wherein the stream of events are associated with the local device, and the stream of events include one or more out-of-order events;
executing a first complex event processing query against the stream of events;
processing the stream of events based on multiple levels of consistency defined by a set of operators;
correcting the out-of-order events based on the set of operators;
generating a first output in which consistency is guaranteed based on the corrected out-of-order events; and
sending the first output to a server that performs complex event processing on the output.

2. The method recited in claim 1, comprising:
identifying an alert condition for the local device; and
displaying an alert at the local device based on the alert condition.

3. The method recited in claim 1, wherein the first output comprises local analytics.

4. The method recited in claim 1, comprising:
receiving a stream of aggregated events from a plurality of local devices, wherein the aggregated stream of events from the plurality of local devices comprise:
the output; and
one or more out-of-order aggregated events;
executing a second complex event processing query against the stream of aggregated events;
processing the stream of aggregated events based on the multiple levels of consistency defined by the set of operators;
correcting the out-of-order aggregated events based on the set of operators;
generating a second output in which consistency is guaranteed based on the corrected out-of-order aggregated events.

5. The method recited in claim 4, wherein the plurality of local devices comprise a plurality of device categories.

6. The method recited in claim 4, wherein the second output comprises global analytics.

7. The method recited in claim 4, wherein the second complex event processing query and the first complex event processing query are executed as a chained operation.

8. The method recited in claim 4, wherein the first complex event query is executable on the back end server, and the second complex event query is executable on the local device.

9. The method recited in claim 4, wherein the server comprises a cloud service comprising the second complex event processing query.

10. The method recited in claim 4, wherein the server comprises a back end server comprising the second complex event processing query.

11. A system for executing a transaction on a distributed platform, comprising:
a processing unit; and
a system memory, wherein the system memory comprises code configured to direct the processing unit to:
perform complex event processing on a local device, for a local stream for the local device that comprises one or more out-of-order events;
generate an aggregate stream based on the complex event processing on the local device, wherein each of a specified set of operators:
performs an operation; and
places the out-of-order events in sequence in the aggregate stream; and
send the aggregate stream to a server for further complex event processing.

12. The system recited in claim 11, wherein the specified set of operators comprises one of:
select;
join;
sum;
align;
finalize;
aggregation;
windowing;
alterlifetime; or
combinations thereof.

13. The system recited in claim 11, comprising code configured to direct the processing unit to generate local analytics based on the complex event processing.

14. The system recited in claim 11, comprising code configured to direct the processing unit to:
perform complex event processing on the server, for a plurality of aggregate streams, comprises one or more out-of-order aggregate events;
generate a global stream based on the complex event processing on the server, wherein each of the specified set of operators:
performs an operation; and
places the out-of-order aggregate events in sequence in the global stream.

15. The system recited in claim 14, wherein the plurality of aggregate streams are generated by a plurality of local devices, wherein the plurality of devices varies by type.

16. The system recited in claim 14, wherein the complex event processing query on the local device and the complex event processing on the server are executed as a chained operation.

17. The system recited in claim 11, comprising code configured to direct the processing unit to:
detect an alert condition on the local device based on the local analytics; and
activate a diagnostic complex event processing query on the local device in response to detecting the alert condition.

18. The system recited in claim 17, comprising code configured to direct the processing unit to:
determine a resolution to the alert condition; and
deploy new complex event processing based on the resolution to a plurality of local devices.

19. One or more computer-readable storage media, comprising code configured to direct a processing unit to:
perform complex event processing on a local device, for a local stream for the local device that comprises one or more out-of-order events;
generate an aggregate stream based on the complex event processing on the local device, wherein each of a specified set of operators:
performs an operation; and
places the out-of-order events in sequence in the aggregate stream;
generate local analytics for the local device based on the complex event processing; and
display an interface comprising the local analytics.

20. The computer-readable storage media recited in claim 19, comprising code configured to direct the processing unit to send the aggregate stream to a server for further complex event processing.
